(19) United States
(12) Patent Application Publication
(10) Pub. No.: US 2002/0080817 A1
(43) Pub. Date: Jun. 27, 2002

(54) Method for phase-synchronous supply of an optical pulsed signal or an optical NRZ transmission signal and an electricla data signal

(76) Inventors: Christoph Glingener, Feldkirchen-Westerham (DE); Erich Gottwald, Holzkirchen (DE)

Correspondence Address: BELL, BOYD & LLOYD, LLC, P. O. BOX 1135, CHICAGO, IL, 60690-1135, US

(21) Appl. No.: 09/963,953

(22) Filed: Sep. 26, 2001

(30) Foreign Application Priority Data
Sep. 26, 2000 (DE) 10047660.0

(51) Int. Cl. H04J 3/16

(52) U.S. Cl. 370/465

(57) ABSTRACT

Method for phase-synchronous supply of an optical pulsed signal or an optical NRZ transmission signal and an electrical data signal, wherein an optical pulsed signal and an electrical data signal which are synchronized with respect to an electrical clock signal are supplied to an electrooptical modulator in order to produce an optical RZ transmission signal. In order to control the phase-synchronous supply, a portion of the optical RZ transmission signal is output, and the output portion is converted to an electrical signal. The power, the current or the voltage of the electrical signal is then determined in a narrow frequency band around the frequency which corresponds to half the data rate, and the determined power, current or voltage values are used to control the phase-synchronous supply of the optical pulsed signal and/or of the electrical data signal.

### BACKGROUND OF THE INVENTION

The present invention relates to a method for phase-synchronous supply of an optical pulsed signal and an electrical data signal which are synchronized with respect to an electrical clock signal, to an electrooptical modulator for producing an optical RZ (Return to Zero) transmission signal. Alternatively, a method is considered according to the present invention for phase-synchronous supply of an electrical data signal to an electrooptical modulator and/or of the optical NRZ (Non-Return to Zero) transmission signal, which is produced in the electrooptical modulator from an optical signal and from the electrical data signal, to a pulse transformer which transforms the optical NRZ transmission signal to an optical RZ (Return to Zero) transmission signal, with the pulse transformer being synchronized to the electrical data signal via an electrical clock signal.

In optical transmission systems, particularly wavelength division multiplexing (WDM) long-distance traffic transmission systems, optical transmission signals are transmitted at data rates of 10 Gigabits per second, or more. For this purpose, the optical transmission signals are coded, for example using RZ transmission format. The RZ transmission format or coding format for optical signals has the particular advantage over the NRZ transmission format that, at a transmission rate of 40 Gbit/s, for example, in an optical long-distance traffic system or optical transmission system, the transmission distance which can be bridged without regeneration can be virtually doubled. For more information on this subject, see “Performance limits on nonlinear RZ and NRZ coded transmission at 10 and 40 Gbit/s on different fibers”, C. Fürst, G. Mohs, H. Geiger, G. Fischer, Siemens A G, Advanced Transport Systems, OFC 2000, Baltimore, USA.

Optical transmission units which are suitable for producing RZ transmission signals are implemented in such a manner that an optical pulsed signal from a pulsed signal source, particularly an optical laser pulsed signal source, are modulated with an electrical data signal via an electrooptical modulator. To accomplish this, the electrical data signal and the pulsed source must be synchronized via an electrical clock signal.

Correspondingly, methods are known in which an optical signal (e.g., from a laser unit), is initially modulated with the electrical data signal and is used to produce an optical NRZ transmission signal, which is then transformed via a pulse transformer from the NRZ data format to the RZ data format. Again, the electrical data signal must be synchronized to the pulse transformer via an electrical clock signal.

An additional factor in both the proposed methods, in contrast with the production of NRZ transmission signals, is that phase synchronization is required between the optical pulsed source and the electrooptical modulator, as well as between the pulse transformer and the electrooptical modulator. Thus, the optical pulsed signal required to produce the optical RZ transmission signal and the electrical data signal must be supplied synchronized in phase to the electrooptical modulator in order to avoid phase mismatches. Alternatively, the optical NRZ transmission signal required for producing the optical RZ transmission signal via a pulse transformer, and the electrical data signal, must be supplied synchronized in phase to the pulse transformer and to the electrooptical modulator. Any phase mismatch would lead to a reduction in the signal amplitude of the transmitted binary “ones”, and to an increase in the signal amplitude of the transmitted binary “zeros” within the optical RZ transmission signal, as a result of which the transmission path length which the optical RZ transmission signal can bridge without regeneration is considerably shortened.

An object of the present invention is, therefore, to provide a method for phase-synchronous supply of an optical pulsed signal or optical NRZ transmission signal and an electrical data signal to an electrooptical modulator.

### SUMMARY OF THE INVENTION

One advantage of the method according to the present invention is that a portion of the optical RZ transmission signal is output, and the output portion of the optical RZ transmission signal is converted to an electrical signal. The power, current or voltage of the electrical signal is then determined in a frequency band whose mid-frequency corresponds to half the data rate, and the phase-synchronous supply of the optical pulsed signal and/or of the electrical data signal is controlled on the basis of the determined power, current or voltage values. In a control method according to the present invention, the spectral component of the output portion of the optical RZ transmission signal at half the data rate is filtered out via a narrowband filter and, for example, its power, current or voltage is determined. The filtered portion of the 0-1 sequence of the converted RZ transmission signal is essentially represented by a sinusoidal signal at a frequency that corresponds to half the data rate and whose voltage amplitude, power amplitude or current amplitude is at a maximum when the supply is synchronized in phase. The determined power, current or voltage values, for example, are evaluated in an advantageous manner to form a control signal, via which a controllable electrical and/or optical phase control element is controlled. Thus, it becomes particularly simple to supply the optical pulsed signal and the electrical data signal synchronized in phase to an electrooptical modulator in order to produce an optical RZ transmission signal with a modulation level of virtually 100%.

Preferably, a method is specified for phase-synchronous supply of an electrical data signal to an electrooptical modulator and/or of the optical NRZ transmission signal, which is produced in the electrooptical modulator from an optical signal and from the electrical data signal, to a pulse transformer which transforms the optical NRZ transmission signal to an optical RZ transmission signal, with the pulse transformer being synchronized to the electrical data signal via an electrical clock signal, in which, once again, a portion of the optical RZ transmission signal is output, and the output portion of the optical RZ transmission signal is converted to an electrical signal. The power, the current or the voltage of the electrical signal is then determined in a frequency band about the mid-frequency that corresponds to half the data rate, and the determined power, current or voltage values are then used to control the phase-synchronous supply of the optical signal and/or of the NRZ transmission signal. A control method according to the present invention for phase-synchronous supply of the electrical data signal and/or of the optical NRZ transmission signal that is formed is used for the alternative production of an optical RZ transmission signal.

A further advantage of a method according to the present invention is that the output portion of the optical RZ transmission signal is converted via an optoelectronic transducer, such as a photodiode, to an electrical signal, and that the power, current or voltage of the electrical signal at the frequency corresponding to half the data rate is determined via an electrical bandpass filter, or is carried out via a narrowband electrical amplifier. The output portion of the optical RZ transmission system may be converted to an electrical signal, for example, via a fast photodiode, and the spectral component of the electrical signal which is relevant to a control method according to the present invention and is at half the data rate is determined cost-effectively via a narrowband electrical bandpass filter or a narrowband amplifier, whose passband or gain range, respectively, includes half the data rate.

In a further embodiment of the present invention, the fundamental of the determined power, current or voltage values is maximized for a control method according to the present invention, and the mathematical sign of the control error is determined by “wobbling” the operating point of the controllable electrical and/or optical delay time element. Thus, the controllable electrical and/or optical delay time element is controlled on the basis of the analog “lock-in principle”, or via a digital controller.

Additional features and advantages of the present invention are described in, and will be apparent from, the following Detailed Description of the Invention and the Figures.

### BRIEF DESCRIPTION OF THE FIGURES

FIG. 1 shows a circuit diagram for producing an optical RZ transmission signal with phase control in accordance with the principles of the present invention.

FIG. 2 shows a circuit diagram for producing an optical RZ transmission signal with matched phase control in accordance with the principles of the present invention.

FIG. 3 shows a graph illustrating the relationship between the determined power of the filtered electrical signal and the phase mismatch between the pulse source and the electrical data signal.

### DETAILED DESCRIPTION OF THE INVENTION

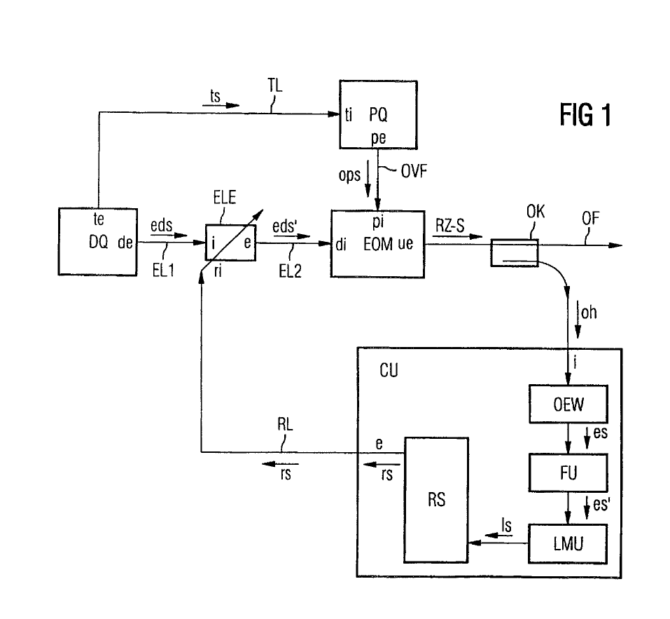

FIG. 1 shows a circuit diagram for producing an optical RZ transmission signal RZ-S, with a control unit CU being provided for phase-synchronous supply, in accordance with the principles of the present invention, of an optical pulsed signal ops and an electrical data signal eds. Additionally, FIG. 1 shows a data signal source DQ, an optical pulsed signal source PQ, a controllable electrical delay time element ELE, an electrooptical modulator EOM and an optical coupling unit OK. Furthermore, the control unit CU has an optoelectrical transducer unit OEW, a filter unit FU, a power determination unit LMU and a regulator unit RS.

The data signal source DQ has a clock signal output te and a data signal output de, with the clock signal output te being connected via a clock line TL to the clock input ti of the pulsed signal source PQ, and the data output de being connected via a first electrical connecting line EL1 to the input i of a controllable electrical delay time element ELE. The output e of the controllable electrical delay time element ELE is connected via a second electrical connecting line EL2 to the data input di of the electrooptical modulator EOM, whose pulsed signal input pi is connected via an optical connecting fiber OVF to the pulsed signal output pe of the pulsed signal unit PQ. Correspondingly, the transmission signal output ue of the electrooptical modulator EOM is connected to the optical transmission fiber OF, which is passed via an optical coupling unit OK. The optical coupling unit OK is also connected via an optical coupling fiber OKF to the input i of the control unit CU. Finally, the output e of the control unit CU is connected via a control line RL to the control input ri of the controllable electrical delay time element ELE.

The input i of the control unit CU is connected to the optoelectrical transducer unit OEW, which is connected to the filter unit FU. Furthermore, the filter unit FU is connected via the power determination unit LMU to the regulator unit RS, which is connected to the output e of the control unit CU.

An electrical data signal eds and a clock signal ts are produced in the data signal source DQ, and are applied to the data output de and to the clock output te, respectively, of the data signal source DQ. From the clock output te, the clock signal ts is transmitted via the clock line TL to the clock input ti of the pulsed signal source PQ. In a similar manner, the electrical data signal eds is supplied via the first electrical line ELI to the input i of the controllable electrical delay time element ELE and, after correction and control of its delay time, it is transmitted via the output e and via the second output electrical line EL2 to the data input di of the electrooptical modulator EOM.

An optical pulsed signal ops, which is passed to the pump signal output pe of the pump signal source PQ, is produced in the pulsed signal source PQ on the basis of the clock signal ts received at the clock input ti. The optical pulsed signal ops is supplied from the pump signal output pe via the optical connecting fiber OVF to the pulsed signal input pi of the electrooptical modulator EOM. Within the electrooptical modulator EOM, the received optical pulsed signal ops is modulated with the received, phase-matched electrical data signal eds', thus forming the RZ transmission signal RZ-S, which is emitted at the transmission signal output ue of the electrooptical modulator EOM. The RZ transmission signal RZ-S is transmitted by the transmission signal eu via the optical transmission fiber OF, and hence via the optical coupling unit OK, to the optical receiving unit (not shown in FIG. 1).

The optical coupling unit OK is used to output a portion of the optical RZ transmission signal RZ-S, and the optical auxiliary signal oh obtained in this way is transmitted via an optical coupling fiber OKF to the input i of the control unit CU. Within the control unit CU, the optical auxiliary signal oh is passed to the optoelectrical transducer unit OEW, where the optical auxiliary signal oh is converted to an electrical signal es. The electrical signal es is then supplied to the filter unit FU and, according to the present invention, that frequency which corresponds to half the data rate, or the spectral component of the electrical signal es, at half the data rate, is filtered out of the electrical signal es. This is based on the effect that the essential portion of the data signal, the RZ transmission signal RZ-S, that remains when an optical pulse sequence is bandpass-filtered is the sinusoidal component at the frequency corresponding to half the data rate. In the event of any phase synchronization errors or phase mismatches between the optical pulsed signal ops and the electrical data signal eds, the pulse amplitude of transmitted “ones” is attenuated and the transmitted pulse amplitude of transmitted “zeros” is increased, which leads to enormous problems in reconstruction of the data signals at the end of the optical transmission path.

Preferabky, a fast photodiode, is used as the optoelectrical transducer element OEW. Preferably, the filter unit FU is in the form of a bandpass filter whose passband is limited closely about half the data frequency, although a correspondingly narrowband electrical amplifier may be used as an alternative.

The spectrum of the optical RZ transmission signal RZ-S varies characteristically with the phase synchronization error. This characteristic variation is evaluated, according to the present invention, for forming a control signal rs to control the controllable electrical delay time ELE, or to control a controllable optical delay time element OLE. For this purpose, the power of the filtered electrical signal es', for example, is determined at half the data rate via the power determination unit LMU, and the determined power ls is signaled to the regulator unit RS on the basis of the power signal ls. Alternatively, the current or the voltage of the filtered electrical signal es' may be determined and evaluated.

In the regulator unit RS, the power signal ls is evaluated, and a control signal rs is formed on the basis of the determined power, current or voltage values and is transmitted via the output e of the control unit CU, via the control line RL, to the control input ri of the electrically controllable delay time element ELE. The delay time of the electrical data signal eds is controlled via the control signal rs, and/or the phase of the electrical data signal eds is varied in such a manner, that the optical pulsed signal ops and the electrical data signal eds, which are both synchronized with respect to the electrical clock signal ts, are supplied synchronized in phase to the electrooptical modulator EOM. When the optical pulsed signal ops and the electrical data signal eds are supplied synchronized in phase, this results in the optimum optical RZ transmission signal RZ-S modulation level.

The fundamental of the determined power, current or voltage values is, for example, maximized in the control method according to the present invention, with the mathematical sign of the control error being determined by wobbling (periodically varying the delay time shift by a small amount via wobble voltages), thus, the optimum setting of the operating point of the controllable electrical delay time element ELE is set either by using an analog “lock-in principle” or by digital control.

An electrically variable broadband phase shifter may be used, for example, as the controllable electrical delay time element ELE. According to the present invention, an optically controllable delay time element OLE (not shown explicitly in FIG. 1) may be provided instead of the controllable electrical delay time element ELE, and is connected between the optical pulsed signal source PQ and the electrooptical modulator EOM. The delay time of the optical pulsed signal ops is controlled via the optically controllable delay time element OLE, so that the optical pulsed signal ops and the electrical data signal eds are supplied, synchronized in phase, to the electrooptical modulator EOM. A number of variants are possible according to the present invention. Preferably, not only can the electrical data signal eds be controlled via the controllable electrical delay time element ELE, but the optical pulsed signal ops can also be controlled via the controllable optical delay time element OLE, virtually simultaneously, in terms of their phase, in order to ensure that the two signals are supplied optimally, synchronized in phase, to the electrooptical modulator EOM. In a similar manner, the controllable optical delay time element OLE is also controlled via the control signal rs produced in the control unit CU.

Furthermore, as an alternative for controlling the electrical data signal eds, it is also feasible to control the phase of the electrical clock signal ts, for which purpose a further, or the controllable electrical, delay time element ELE is connected between the data signal source DQ and the pulsed signal source PQ, in order to control the phase of the clock signal ts. Again, the method according to the present invention also includes control not only of the electrical data signal eds but also of the clock signal ts via a first and a second controllable electrical delay time element ELE (not shown in FIG. 1).

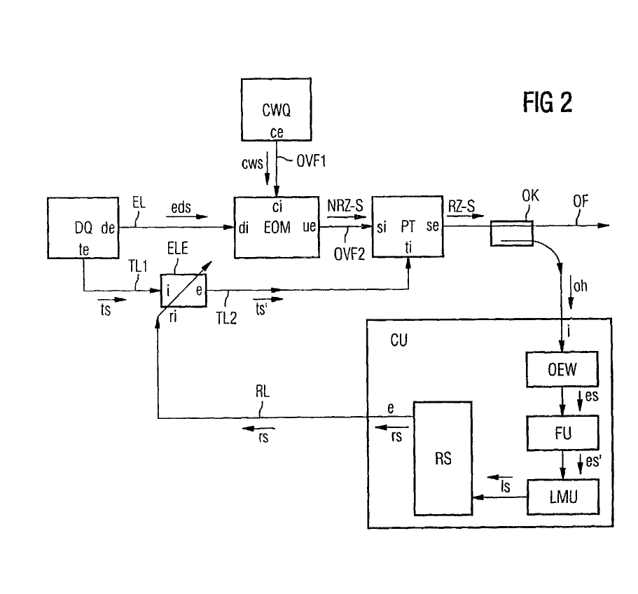

FIG. 2 shows a circuit diagram for producing an optical RZ transmission signal RZ-S. In comparison to the exemplary embodiment illustrated in FIG. 1, FIG. 2 has an optical constant signal source CWQ and a pulse transformer PT instead of the pulsed signal source PQ. An advantageous feature of this method is that it allows RZ-format NRZ transmitters already in existence to be retrofitted via an assembly, which includes an electrically controllable delay time element ELE, the pulse transformer PT, and a control unit CU. The data signal source DQ once again has a clock output te and a data output de, with the clock output te being connected via a first clock line TL1 to the input i of the electrically controllable delay time element ELE, and the data output de being connected via the electrical line EL to the data input di of the electrooptical modulator EOM.

The output e of the controllable electrical delay time element ELE is connected via a second clock line TL2 to the clock input ti of the pulse transformer PT. Correspondingly, the constant signal source CWQ is connected via its constant signal output ce and via a first optical connecting fiber OVF1 to the constant signal input ci of the electrooptical modulator EOM. The transmission signal output ue of the electrooptical modulator EOM is connected via a second optical connecting fiber OVF2 to the signal input si of the pulse transformer PT, whose signal output se is passed to the optical transmission fiber OF. In a similar manner to the exemplary embodiment illustrated in FIG. 1, the optical transmission fiber OF is passed via an optical coupling unit OK to an optical receiving unit (not illustrated in FIG. 2), with the optical coupling unit OK being connected via an optical coupling fiber OKF to the input i of the control unit CU. The output e of the control unit CU is connected, similarly to FIG. 1, via a control line RL to the control input ri of the controllable electrical delay time element ELE.

The control unit CU illustrated in FIG. 2 is constructed similarly to the control unit CU illustrated in FIG. 1. Accordingly, the control unit CU contains an optoelectrical transducer unit OEW, a filter unit FU, a power determination unit LMU and a regulating unit RS.

In contrast to the production of an RZ transmission signal RZ-S as shown in the exemplary embodiment in FIG. 1, an NRZ transmission signal is first of all formed via the electrooptical modulator EOM in the alternative embodiment according to the present invention, and is converted or transformed to an RZ transmission signal RZ-S via the pulse transformer PT. To accomplish this, an electrical data signal eds and an electrical clock signal ts are formed in the data signal source DQ. The electrical data signal eds is transmitted from the data signal source DQ via the electrical line EL to the data input di of the electrooptical modulator EOM. Correspondingly, the clock signal ts is passed from the data signal source DQ via the first clock line TL1 to the input i of the electrically controllable delay time element ELE. The delay time of the clock signal ts is varied via the controllable electrical delay time element ELE, or its phase is corrected in this way, and the phase-corrected clock signal ts' is transmitted from the output e of the controllable electrical delay time element ELE, via the second clock line TL2, to the clock input ti of the pulse transformer PT.

An optical signal cws is formed in the constant signal source CWQ, and is transmitted from the constant signal output ce via the first optical connecting fiber OVF1 to the constant signal input ci of the electrooptical modulator EOM. The optical signal cws is modulated via the electrical data signal eds that is passed to the electrooptical modulator EOM, so that an optical NRZ transmission signal NRZ-S is produced, which is transmitted from the transmission signal output ue of the electrooptical modulator EOM via the second optical connecting fiber OVF2 to the signal input si of the pulse transformer. The pulse transformer PT is used to convert or transform the optical NRZ transmission signal NRZ-S to an optical RZ transmission signal RZ-S, which is emitted at the signal output se. A portion of the optical RZ transmission signal RZ-S transmitted via the optical transmission fiber OF is output via the optical coupling unit OK, and is transmitted as an optical auxiliary signal oh via the optical coupling fiber OKF to the input i of the control unit CU. In a similar manner to the embodiment described in FIG. 1, a control signal rs is determined from the optical auxiliary signal oh, and is supplied to the control input ri of the controllable electrical delay time element ELE, in order to control it.

As illustrated in FIG. 2, the phase-synchronous supply of an electrical data signal eds to an electrooptical modulator EOM and/or the phase-synchronous supply of the optical NRZ transmission signal NRZ-S (which is produced in the electrooptical modulator EOM from the electrical signal cws and from the electrical data signal eds) to the pulse transformer PT, which transforms the NRZ transmission signal to an optical RZ transmission signal RZ-S is controlled, with the pulse transformer PT being synchronized to the electrical data signal eds via an electrical clock signal ts. According to the present invention, the electrical clock signal ts is subjected to phase correction via the controllable electrical delay time element ELE, so that it is possible to provide the phase-synchronous supply.

Preferably, the phase angle of the electrical data signal eds is controlled via an electrically controllable delay time element ELE, and the NRZ transmission signal NRZ-S formed in the electrooptical modulator EOM is controlled via a controllable optical delay time element OLE. Thus, the optically controllable delay time element OLE (not illustrated in FIG. 2) is connected between the electrooptical modulator EOM and the pulse transformer PT, thereby controlling the phase of the optical NRZ transmission signal NRZ-S. Thus, the optical pulsed signal ops in FIG. 1 or the optical NRZ transmission signal NRZ-S in FIG. 2 may be supplied, according to the present invention, synchronized in phase via a controllable optical delay time element OLE.

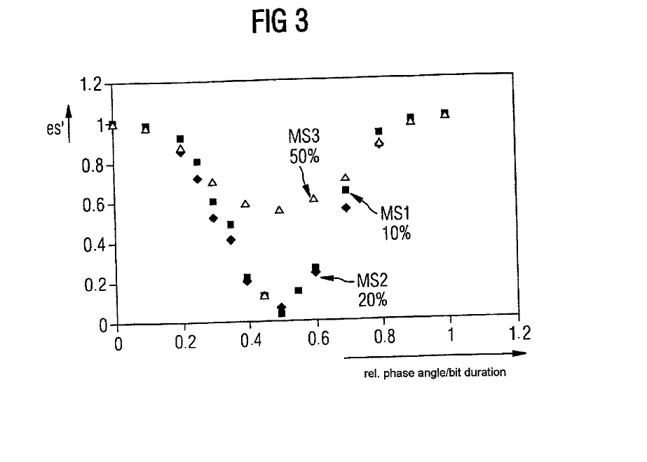

FIG. 3 shows a graph illustrating the relationship between the power of the filtered electrical signal es' at half the data rate, and the phase mismatch between the phase of the optical pulsed signal ops and that of the electrical data signal eds, showing first, second and third measurement signals MS1, MS2, MS3, whose durations differ from the relative pulse duration of the optical pulsed signal ops.

The first measurement signal MS1 has a 10% relative pulse duration, the second measurement signal MS2 a 20% relative pulse duration, and the third measurement signal a 50% relative pulse duration, with the reference variable for the relative pulse duration being the time period between two successive transmitted bits. The first measurement signal is represented by measurement points in the form of squares, the second measurement signal MS2 by diamond-shaped measurement points, and the third measurement signal MS3 by triangular measurement points. The ordinate shows the relative phase angle per bit duration in normalized form, while the abscissa shows the normalized power of the filtered electrical signal es' at half the data rate.

The graph in FIG. 3 clearly shows that, when the optical pulsed signal ops and the electrical data signal eds are supplied synchronized in phase to the electrooptical modulator EOM, the power of the electrical signal es', determined at half the data rate, is at a maximum. Thus, the normalized power of the electrical signal es' reaches a maximum at the ordinate values 0 and 1. As the phase mismatch increases, the power of the filtered electrical signal es' falls to an increasing extent, until, finally, it reaches a minimum at the normalized ordinate value 0.5. Thus, the phases of the electrical data signal eds and of the optical pulse signal ops are shifted through half a cycle with respect to one another. This minimum is itself highly dependent on the relative pulse duration of the optical pulsed signal ops. The graph thus clearly shows that, for example, if the first measurement signal MS1 has a relative pulse duration of 10%, the power of the filtered electrical signal es' assumes a power value of virtually 0. Likewise, the power of the filtered electrical signal es' for the second measurement signal MS2 approaches the value 0 at the ordinate value 0.5. In contrast, the third measurement signal MS3, which has a relative pulse duration of 50%, reaches a minimum of 0.55 of the normalized power of the filtered electrical signal es' at the ordinate value 0.5 under consideration.

In the event of a phase shift through one complete cycle, which corresponds to the normalized ordinate value 1 for the relative phase angle per bit duration, the first, second and third measurement signals once again reach a maximum power for the filtered electrical signal es'.

It is clear from the relationship illustrated in FIG. 3 that according to the present invention, a synchronization criterion for controlling the electrical or optical controllable delay time element ELE, OLE may be obtained from the determined power, voltage or current values of the filtered electrical signal es' at half the data transmission rate, with this being evaluated to form a control signal rs for the control method according to the present invention.

Although the present invention has been described with reference to specific embodiments, those of skill in the art will recognize that changes may be made thereto without departing from the spirit and scope of the invention as set forth in the hereafter appended claims.

1. A method for phase-synchronous supplying of an optical pulsed signal and an electrical data signal to an electrooptical modulator for producing an optical RZ transmission signal, wherein the optical pulsed signal and the electrical data signal are synchronized with respect to an electrical clock signal, the method comprising the steps of:
outputting a portion of the optical RZ transmission signal;
converting the output portion of the optical RZ transmission signal to an electrical signal;
establishing at least one of the power, the current and the voltage of the electrical signal in a narrow frequency band around a frequency that corresponds to half the data rate; and
controlling the phase-synchronous supplying of at least one of the optical pulsed signal and the electrical data signal based on at least one of the established power, current and voltage values.

2. A method for phase-synchronous supplying as claimed in claim 1, the method further comprising the step of controlling the phase-synchronous supplying of the optical pulsed signal via a controllable optical delay time element.

3. A method for phase-synchronous supplying as claimed in claim 2, the method further comprising the steps of:
forming at least one control signal using at least one of the established power, current and voltage values; and
supplying the control signal to the to the controllable optical delay time element.

4. A method for phase-synchronous supplying as claimed in claim 1, the method further comprising the step of controlling the phase-synchronous supplying of at least one of the electrical data signal and of the electrical clock signal via a controllable electrical delay time element.

5. A method for phase-synchronous supplying as claimed in claim 3, the method further comprising the steps of:
forming at least one control signal using at least one of the established power, current and voltage values; and
supplying the control signal to the controllable electrical delay time element.

6. A method for phase-synchronous supplying as claimed in claim 1, wherein at least one of the power, the current and the voltage of the electrical signal for the frequency corresponding to half the data rate is determined via one of an electrical bandpass filter and a narrowband electrical amplifier.

7. A method for phase-synchronous supplying as claimed in claim 1, wherein the output portion of the optical RZ transmission signal is converted to an electrical signal via an optoelectrical transducer.

8. A method for phase-synchronous supplying as claimed in claim 7, wherein the optoelectrical transducer is a photodiode.

9. A method for phase-synchronous supplying as claimed in claim 2, the method further comprising the step of, before being supplied to the electrooptical modulator, varying the delay time of the optical pulsed signal via the controllable optical delay time element.

10. A method for phase-synchronous supplying as claimed in claim 4, the method further comprising the step of, before being supplied to the electrooptical modulator, varying the delay time of at least one of the electrical data signal and the electrical clock signal via the controllable electrical delay time element.

11. A method for phase-synchronous supplying as claimed in claim 2, the method further comprising the step of maximizing, for control purposes, a fundamental of at least one of the established power, current and voltage values.

12. A method for phase-synchronous supplying as claimed in claim 11, wherein a mathematical sign of a control error is determined by wobbling an operating point of the controllable optical delay time element.

13. A method for phase-synchronous supplying as claimed in claim 4, the method further comprising the step of maximizing, for control purposes, a fundamental of at least one of the established power, current and voltage values.

14. A method for phase-synchronous supplying as claimed in claim 13, wherein a mathematical sign of a control error is determined by wobbling an operating point of the controllable electrical delay time element.

15. A method for phase-synchronous supplying as claimed in claim 4, wherein the controllable electrical delay time element is an electrically adjustable, broadband phase shifter.

16. A method for phase-synchronous supplying of at least one of an electrical data signal to an electrooptical modulator and of an optical NRZ transmission signal to a pulse transformer which transforms the optical NRZ transmission signal to an optical RZ transmission signal, the NRZ transmission signal being produced in the electrooptical modulator from an optical signal and from the electrical data signal, the pulse transformer being synchronized to the electrical data signal via an electrical clock signal, the method further comprising the steps of:
outputting a portion of the optical RZ transmission signal;
converting the output portion of the optical RZ transmission signal to an electrical signal;
establishing at least one of the power, the current or the voltage of the electrical signal in a narrow frequency band around a frequency that corresponds to half the data rate, and
controlling the phase-synchronous supplying of at least one of the optical NRZ transmission signal and the electrical data signal based on at least one of the established power, current or voltage values.

17. A method for phase-synchronous supplying as claimed in claim 16, the method further comprising the step of controlling the phase-synchronous supplying of the optical NRZ transmission signal via a controllable optical delay time element.

18. A method for phase-synchronous supplying as claimed in claim 17, the method further comprising the steps of:
forming at least one control signal using at least one of the established power, current and voltage values; and
supplying the control signal to the to the controllable optical delay time element.

19. A method for phase-synchronous supplying as claimed in claim 16, the method further comprising the step of controlling the phase-synchronous supplying of at least one of the electrical data signal and of the electrical clock signal via a controllable electrical delay time element.

20. A method for phase-synchronous supplying as claimed in claim 19, the method further comprising the steps of:
forming at least one control signal using at least one of the established power, current and voltage values; and
supplying the control signal to the controllable electrical delay time element.

21. A method for phase-synchronous supplying as claimed in claim 16, wherein at least one of the power, the current and the voltage of the electrical signal for the frequency corresponding to half the data rate is determined via one of an electrical bandpass filter and a narrowband electrical amplifier.

22. A method for phase-synchronous supplying as claimed in claim 16, wherein the output portion of the optical RZ transmission signal is converted to an electrical signal via an optoelectrical transducer.

23. A method for phase-synchronous supplying as claimed in claim 22, wherein the optoelectrical transducer is a photodiode.

24. A method for phase-synchronous supplying as claimed in claim 17, the method further comprising the step of, before transformation by the optical pulse transformer, varying the delay time of the optical NRZ transmission signal via the controllable optical delay time element.

25. A method for phase-synchronous supplying as claimed in claim 19, the method further comprising the step of, before transformation by the optical pulse transformer, varying the delay time of at least one of the electrical data signal and of the electrical clock signal via the controllable electrical delay time element.

26. A method for phase-synchronous supplying as claimed in claim 17, the method further comprising the step of maximizing, for control purposes, a fundamental of at least one of the established power, current and voltage values.

27. A method for phase-synchronous supplying as claimed in claim 26, wherein a mathematical sign of a control error is determined by wobbling an operating point of the controllable optical delay time element.

28. A method for phase-synchronous supplying as claimed in claim 19, the method further comprising the step of maximizing, for control purposes, a fundamental of at least one of the established power, current and voltage values.

29. A method for phase-synchronous supplying as claimed in claim 28, wherein a mathematical sign of a control error is determined by wobbling an operating point of the controllable electrical delay time element.

30. A method for phase-synchronous supplying as claimed in claim 19, wherein the controllable electrical delay time element is an electrically adjustable, broadband phase shifter.
